(19) United States
(12) Patent Application Publication
(10) Pub. No.: US 2012/0312134 A1
(43) Pub. Date: Dec. 13, 2012

(54) ADJUSTABLE SEAL TRIMMER AND METHOD OF USE THEREOF

(75) Inventors: Donald S. Maguire, JR., Cicero, NY (US); Christopher P. Natoli, Fulton, NY (US)

(73) Assignee: JOHN MEZZALINGUA ASSOCIATES, INC., East Syracuse, NY (US)

(21) Appl. No.: 13/419,914

(22) Filed: Mar. 14, 2012

Related U.S. Application Data
(63) Continuation-in-part of application No. 13/157,368, filed on Jun. 10, 2011.

(51) Int. Cl. B26D 3/16; B26D 7/27

(52) U.S. Cl. 83/13; 30/94

(57) ABSTRACT

A seal trimmer comprising a support member having a first end a second end, and a guide portion variably disposed within the support member is provided. An apparatus comprising an inner sleeve portion, an outer sleeve portion, and at least one finger moveably disposed between the inner sleeve portion and the outer sleeve portion, the at least one finger configured to determine a length of a port seal is also provided. Furthermore, a method of sizing and cutting a port seal to fit onto a port, comprising the steps of providing a support member having an inner sleeve portion and an outer sleeve portion defining a cavity therebetween, and a length guide portion variably disposed within the cavity of the support member, inserting the port seal into the cavity, and cutting an exposed portion of the port seal is also provided.

### CROSS-REFERENCE TO RELATED APPLICATIONS

This application is a continuation-in-part and claims priority to U.S. application Ser. No. 13/157,368, filed Jun. 10, 2011, entitled, “Adjustable Seal Trimmer and Method of Use Thereof.”

### FIELD OF TECHNOLOGY

The following relates to a seal trimmer, and more specifically to embodiments of an adjustable seal trimmer for a cutting a port seal to various sizes.

### BACKGROUND

Moisture migration is a problem for coaxial cable ports, especially those regularly exposed to environmental elements. To prevent moisture migration, a port can be sealed with a piece of rubber commonly referred to as a port seal. Because ports have various lengths and sizes, the port seal must be trimmed to fit the existing port. Presently, trimming the port seal to length requires installers to use a great degree of care to both cut the rubber port seal evenly without leaving jagged mismatches on the cut surface of the port seal, as well as estimating the needed length of the port seal. For example, the rubber port seal may deform or squash as the installer's blade attempts to slice through the rubber seal, causing random notches and an overall discontinuous cut surface of the port seal. A port seal that does not have an even cut around its body or a port seal which is shorter than the needed length to cover the port may perform undesirably, including an inability to prevent moisture migration and ingress of other environmental elements.

Thus, a need exists for an apparatus and method for evenly trimming a port seal to its correct length.

### SUMMARY

A first general aspect relates to a seal trimmer comprising a support member having an inner sleeve portion and an outer sleeve portion defining a cavity therebetween, and a length guide portion variably disposed within the cavity of the support member.

A second general aspect relates to an apparatus comprising an inner sleeve portion insertable within the port seal for preventing deformation of the seal under a force of a cutting blade, an outer sleeve portion configured to radially surround a port seal, a bottom surface portion connecting the outer sleeve portion to the inner sleeve portion, wherein the bottom surface portion includes a plurality of openings, and a plurality of axial fingers configured to extend from the bottom surface portion through the plurality of openings, wherein an extension of the plurality of axial fingers determines a length of a port seal.

A third general aspect relates to an annular member having an inner sleeve portion and an outer sleeve portion defining a cavity therebetween, and a means for determining a desired length of a port seal.

A fourth general aspect relates to a method of determining a desired length of a port seal, comprising providing an annular member having an inner sleeve portion and an outer sleeve portion defining a cavity therebetween; and a length guide portion variably disposed within the cavity of the annular member, advancing the length guide portion towards a base portion of a port to vacate a portion of the cavity, and inserting the port seal into the vacated cavity of the support member.

A fifth general aspect relates to a method of determining a desired length of a port seal, comprising providing a support member having an inner sleeve portion and an outer sleeve portion defining a cavity therebetween; and a length guide portion variably disposed within the cavity of the support member, inserting the seal into a second end of the support member to axially displace the length guide portion from the cavity, and trimming an exposed portion of the seal beyond the second end of the support member.

A sixth aspect relates generally to a seal trimmer comprising a support member having a first end a second end, and a guide portion variably disposed within the support member.

A seventh aspect relates generally to an apparatus comprising an inner sleeve portion, an outer sleeve portion, and at least one finger moveably disposed between the inner sleeve portion and the outer sleeve portion, the at least one finger configured to determine a length of a port seal.

An eighth aspect relates generally to a seal trimmer comprising an annular member having an inner sleeve portion and an outer sleeve portion defining a cavity therebetween, and a means for determining a desired length of a port seal and cutting the port seal.

A ninth aspect relates generally to a method of sizing and cutting a port seal to fit onto a port, comprising providing a support member having an inner sleeve portion and an outer sleeve portion defining a cavity therebetween, and a length guide portion variably disposed within the cavity of the support member, inserting the port seal into the cavity, and cutting an exposed portion of the port seal.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1A depicts an schematic perspective view of an embodiment of a seal trimmer, a port, and a port seal prior to placement on the port;

FIG. 1B depicts a perspective view of an embodiment of the seal trimmer being used to determine a length of the port seal;

FIG. 2 depicts a cross-section view of an embodiment of a support member

FIG. 3 depicts a perspective view of an embodiment of the support member;

FIG. 4 depicts an end view of an embodiment of the second end of the support member;

FIG. 5 depicts an end view of an embodiment of the first end of the support member;

FIG. 6 depicts a perspective view of an embodiment of a length guide portion;

FIG. 7A depicts a cross-section view of an embodiment of the seal trimmer in a closed position;

FIG. 7B depicts a perspective view of an embodiment of the seal trimmer in a closed position;

FIG. 8 depicts a cross-section view of an embodiment of the seal trimmer in an extended position;

FIG. 9 depicts a cross-section view of an embodiment of the seal trimmer prior to an insertion of the port seal, in the closed position;

FIG.10 depicts a cross-section view of an embodiment of the seal trimmer after the port seal has been partially inserted into the support member;

FIG. 11 depicts a cross-section view of an embodiment of the seal trimmer in an extended position;

FIG. 12 depicts a perspective view of an embodiment of a seal trimmer having an integral cutting means proximate;

FIG. 13 depicts an exploded assembly view of a second embodiment of a seal trimmer having a rotary cutting means;

FIG. 14 depicts a perspective view of a second embodiment of the seal trimmer having a rotary cutting means;

FIG. 15 depicts a perspective view of a second embodiment of a support member;

FIG. 16 depicts a perspective view of a second embodiment of a length guide portion;

FIG. 17 depicts a perspective view of an embodiment of a retention feature;

FIG. 18 depicts a perspective view of an embodiment of an actuator of a rotary cutting means;

FIG. 19 depicts a perspective view of an embodiment of a rotary tool component of the rotary cutting means;

FIG. 20 depicts a perspective view of an embodiment of a cutting blade of the rotary cutting means;

FIG. 21 depicts a perspective view of an embodiment of a spring means of the rotary cutting means; and

FIG. 22 depicts a cross-section view of a second embodiment of the seal trimmer in a position over a port and a seal inserted therein.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

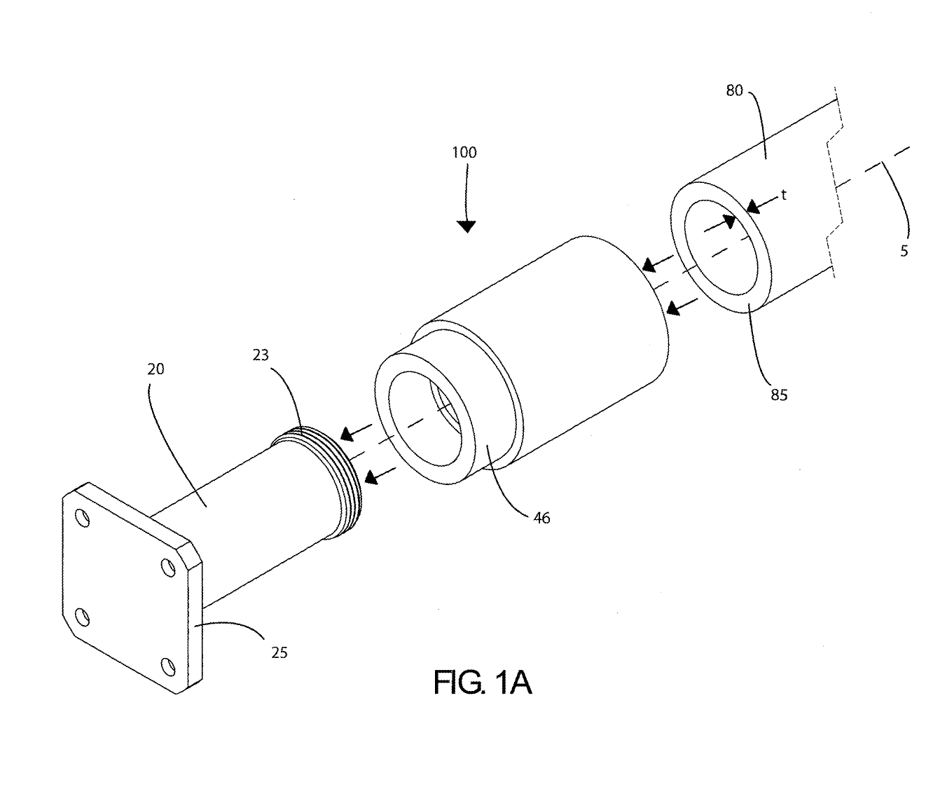

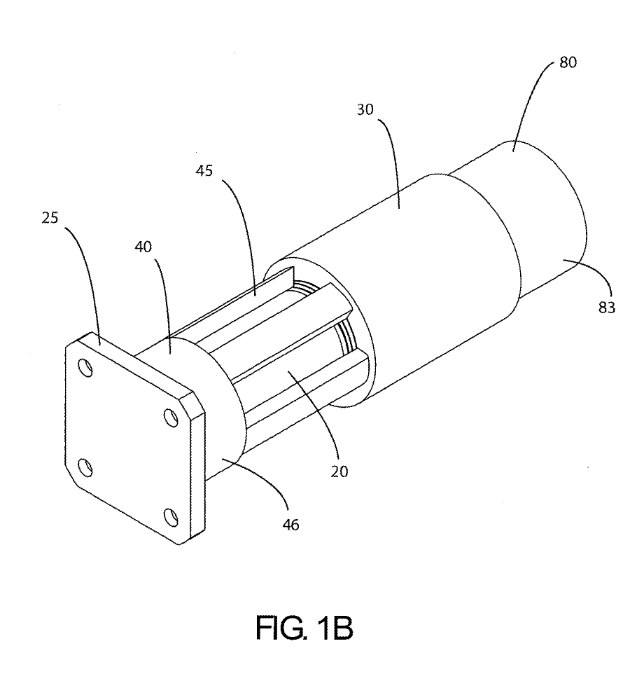

Referring to the drawings, FIGS. 1A and 1B depict embodiments of a seal trimmer 100. Embodiments of seal trimmer 100 may include a support member 30 and a length guide portion 40 operably attached to the support member 30. Embodiments of the seal trimmer 100 may also include a support member 30 having an inner sleeve portion 36 and an outer sleeve portion 38 defining a cavity 37 therebetween, and a length guide portion 40 variably disposed within the cavity 37 of the support member 30. Further embodiments of seal trimmer 100 may include an inner sleeve portion 36 insertable within a port seal 80 for preventing deformation of the port seal 80 under a force of a cutting blade, an outer sleeve portion 38 configured to radially surround the port seal 80, a bottom surface portion 39 connecting the outer sleeve portion 38 to the inner sleeve portion 36, wherein the bottom surface portion 39 includes a plurality of openings 35, and a plurality of axial fingers 45 configured to extend from the bottom surface portion 39 through the plurality of openings 35, wherein an extension of the plurality of axial fingers 45 determines a length of a port seal 80. Moreover, seal trimmer 100 may be used to trim the lengths of a seal, such as a port seal, for placement over a port, such as port 20. For instance, the length, or depth, of a seal, such as seal 80, may need to be cut to match the size of an existing port 20. Furthermore, seal trimmer 100 may prevent the occurrence of irregularities on a cut surface of the seal 80 that may occur when the seal 80 deforms under the force of an installer's knife. Irregularities of a cut surface, or mating edge 85 of the seal 80, may include jagged edges, notches, serrations, or any surface irregularity that may lead to a discontinuous or uneven mating edge 85. The seal trimmer 100 may be provided to an installer in a preassembled configuration or may be assembled as needed to allow for interchangeability of components (e.g. installer may assemble and disassemble a seal trimmer 100 having a support member 30 and a length guide portion 40 having a first size, and swap it out with a length guide portion 40 having a second size).

Embodiments of a seal 80 may be a generally annular tubular member configured to radially surround, or be disposed over, port 20 to provide a seal for environmental elements, such as moisture, contaminants, rainwater, dirt, corrosive elements, and/or other elements which may have deleterious effects on a port 20. Seal 80 may be comprised of an elastomeric material such as rubber, silicone rubber, and the like, having elastomer polymeric characteristics.

Referring still to FIGS. 1A and 1B, embodiments of a port 20 may be a conductive receptacle for receiving a portion of a coaxial cable center conductor (not shown) sufficient to make adequate electrical contact, wherein the port includes a base portion 25 that may be mounted to a structure or other suitable substratum. The port 20 may further comprise a threaded exterior surface 23 to threadably engage a coupling member of a connector, such as coaxial cable connector. The port 20 may be exposed to environmental conditions, such as being located on a cell tower or cell site. Moreover, the radial thickness and/or the length of the port 20 and/or the conductive receptacle of the port 20 may vary based upon generally recognized parameters corresponding to broadband communication standards and/or equipment. Furthermore, it should be noted that the interface port 20 may be formed of a single conductive material, multiple conductive materials, or may be configured with both conductive and non-conductive materials. However, the receptacle of the port 20 should be formed of a conductive material, such as a metal, like brass, copper, or aluminum. Further still, it will be understood by those of ordinary skill that the port 20 may be embodied by a connective interface component of a coaxial cable communications device, a port on a cellular tower, or other communications modifying devices such as a signal splitter, a cable line extender, a cable network module and/or the like.

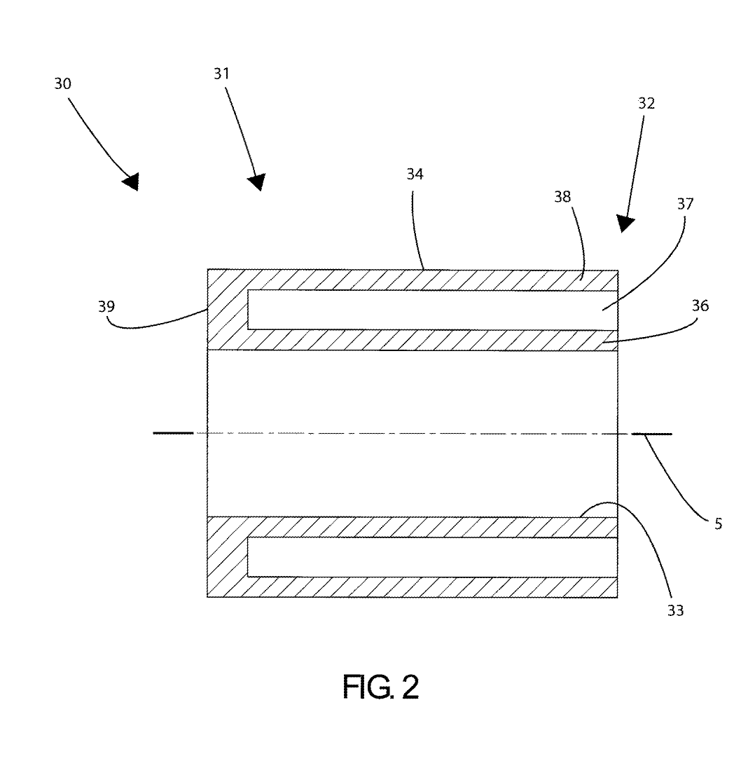

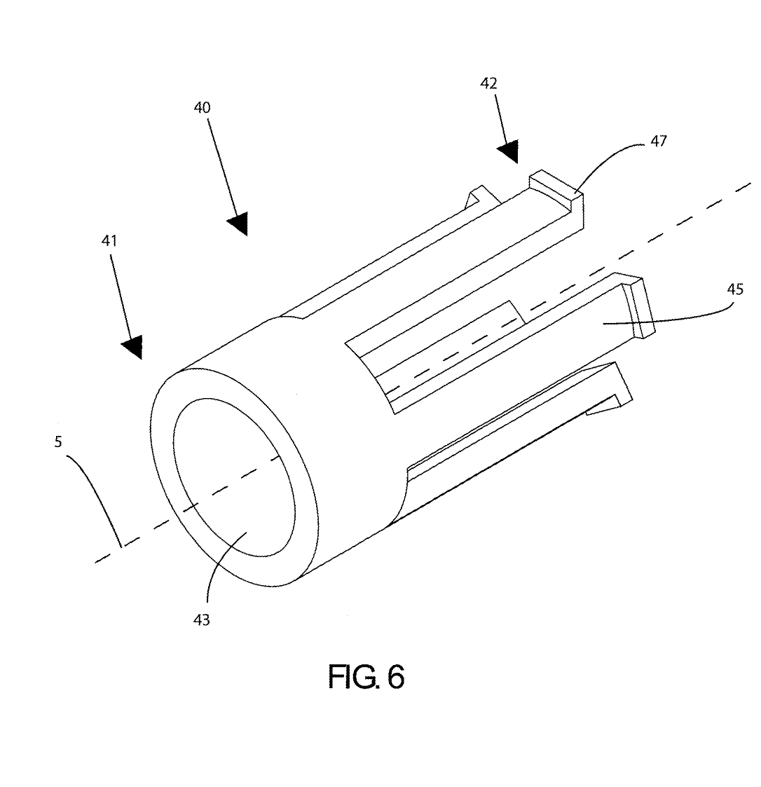

With reference now to FIGS. 2-5, embodiments of a seal trimmer 100 may include a seal support member 30. The support member 30 may accommodate, receive, accept, etc., a seal 80, and may structurally support or prevent the inward deformation of the seal 80 when the seal 80 is being trimmed. In other words, a seal 80 may be insertable within the support member 80 to displace a guide portion 40, described in greater detail supra. The support member 30 may include a first end 31, a second end 32, an inner surface 33, an outer surface 34, and a bottom surface portion 39. The support member 30 may be an annular member having a generally axial opening therethrough. Furthermore, the support member 30 may also include a first portion 36 and a second portion 38. The inner sleeve portion 36 and the outer sleeve portion 36 may be a sleeve, or similar cylindrical shaped portion; however, the inner and outer sleeve portions 36, 38 need not be a continuous cylinder to function properly. Accordingly, embodiments of a seal trimmer 100 may include a first portion 36 and a second portion 38.

Embodiments of an inner sleeve portion 36 and an outer sleeve portion 38 can be structurally integral with a common bottom surface 39 of the support member 30. However, the inner sleeve portion 36 and the outer sleeve portion 38 may be separated by a distance, defining a cavity 37. The distance separating the inner sleeve portion 36 and the outer sleeve portion 38 defining cavity 37 should be at least enough to accommodate a thickness, t, of the seal 80. For example, the radial distance between an inner surface of the outer sleeve portion 38 and the outer surface of the inner sleeve portion 36 may be large enough to accommodate the thickness, t, of the seal 80 as well as permit axial movement of the seal 80 between the outer sleeve portion 38 and the inner sleeve portion 36 in a direction towards and away from the first end 31 of the support member 30. In other words, the inner sleeve portion 36 and the outer sleeve portion 38 may share a concentric and/or radial relationship with respect to a central axis 5 of the seal trimmer 100. Specifically, the outer sleeve portion 38 can be a greater radial distance away from the central axis 5 of the seal trimmer 100 than the inner sleeve portion 38. The difference between the radial distances from the central axis 5 of the seal trimmer 100 of the inner and outer sleeve portions 36, 38 may define cavity 37. The cavity 37 (and the distances between the central axis 5) may vary according to the various types and thicknesses of seal 80. Cavity 37 may be an annular opening, void, space, slot, and the like.

Embodiments of the inner sleeve portion 36 of the support member 30 may be configured to be inserted within the axial opening of the seal 80 (e.g. insertable within an inner diameter of the seal 80). For instance, the seal 80 may be disposed over the inner sleeve portion 36 but within the outer sleeve portion 38 and slid further towards the first end 31 of the support member 30. Once the seal 80 is slid into the support member 30 the requisite distance, an exposed portion 83 of the seal 80 may be cut off to trim the seal 80. The inner sleeve portion 36, due to its rigid characteristics, may prevent the seal 80 from squashing or otherwise deforming under the cutting force of an installer's blade because the seal 80 is disposed over the inner sleeve portion 36. Moreover, the inner sleeve portion 36 may act as a structural cutting edge for ensuring an even, continuous cut completely around the seal 80. Thus, the support provided by the inner sleeve portion 36 to the seal 80 when trimming the exposed portion 83 may reduce or eliminate the likelihood of notches, serrations, or other surface irregularities that may lead to a discontinuous cut surface, or mating edge 85.

Embodiments of the outer sleeve portion 38 of the support member 30 may be configured to surround a portion of the inserted seal 80. For instance, the seal 80 may be inserted into cavity 37 a requisite distance leaving the outer sleeve portion 38 visible to the installer. Because the outer sleeve portion 38 extends the same or substantially the same axial distance from the bottom surface portion 39 as the inner sleeve portion 36, the installer may utilize the edge of the outer sleeve portion 38 proximate the second end 32 of the support member 30 as a trimming guide. In other words, the outer sleeve portion 38 surrounding the seal 80 may indicate to the installer the proximity of the inner sleeve portion 36 so the cutting blade may be properly placed close to an end or edge of the inner sleeve portion 36 without seeing the inner sleeve portion 36. Accordingly, the installer may simply align a cutting blade with the edge of the outer sleeve portion 38 at the second end 32, while the inner sleeve portion 36 provides support (i.e. prevents deformation of the seal 80) to the seal 80 during the slicing of the seal 80.

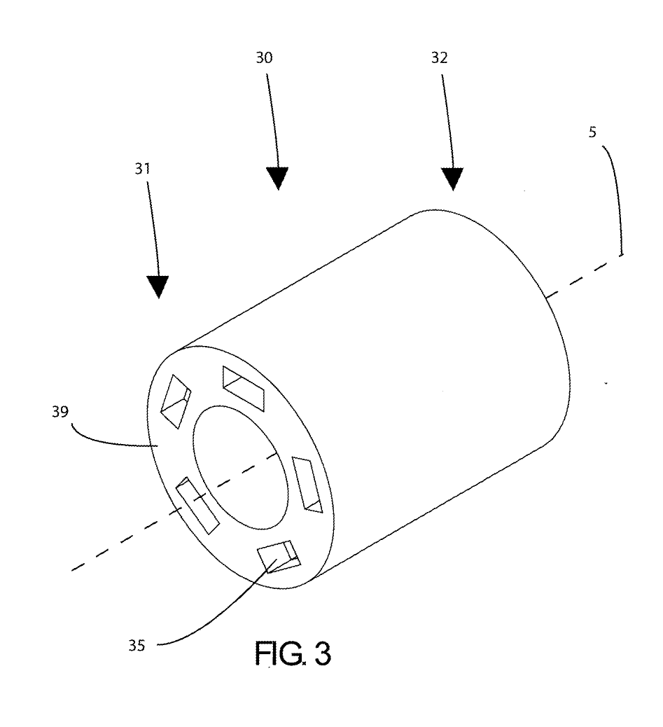

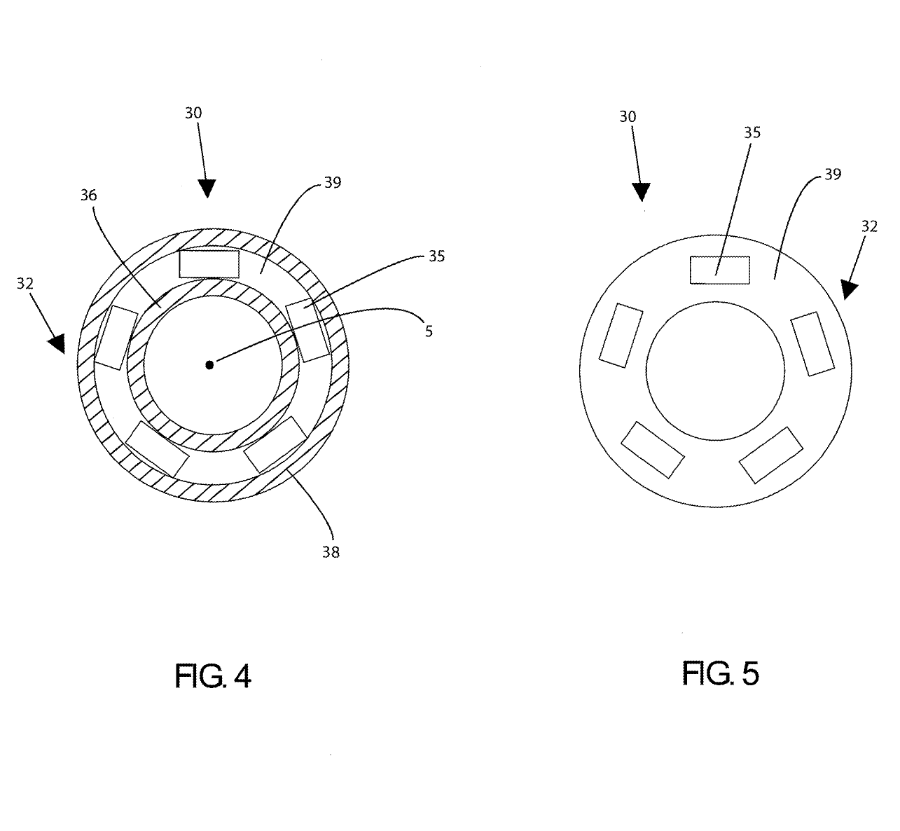

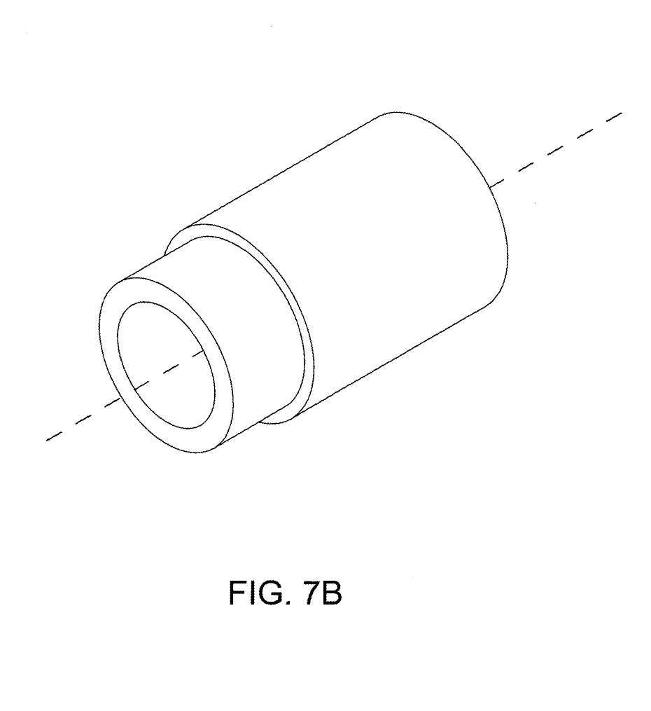

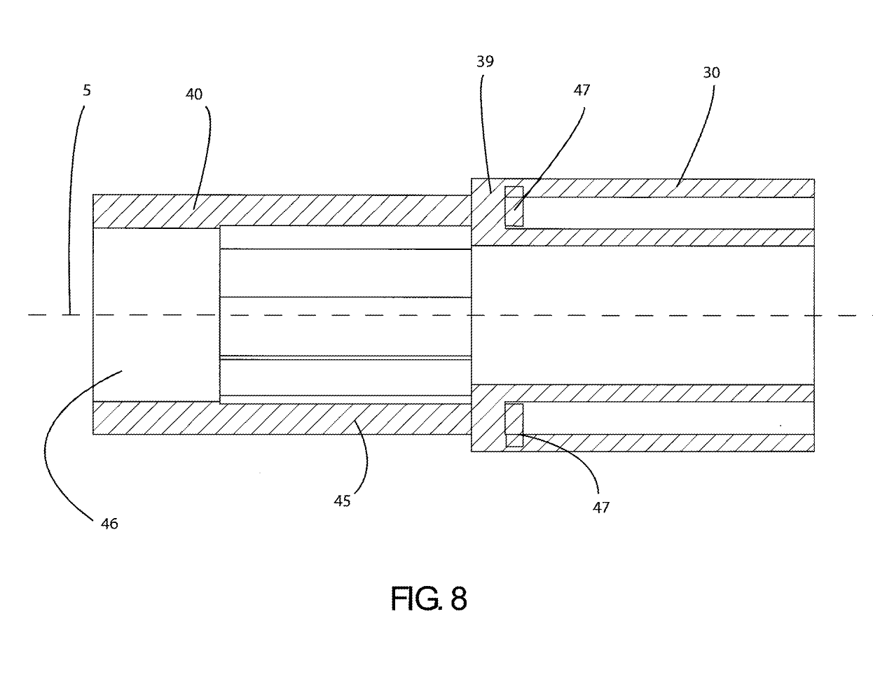

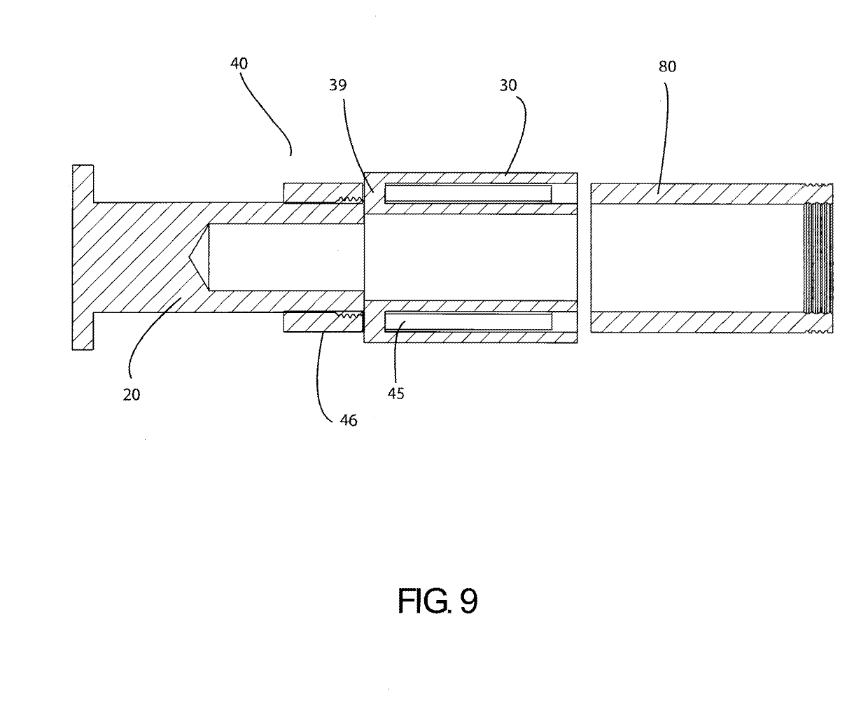

With particular reference to FIGS. 3 and 4, embodiments of the support member 30 may include one or more openings 35 on the bottom surface portion 39 proximate the first end 31 of the support member 30. The opening(s) 35 may be slots, circular holes, punch holes, rectangular or square openings, keyways, C-shaped openings, and the like, that may extend through the thickness of the bottom surface portion 39 of the support member 30. The opening(s) 35 may provide access from external to the support member 30 to the cavity 37 located between the inner and outer sleeve portions 36, 38. In most embodiments, the openings 35 may be sized and dimensioned to provide clearance to allow fingers 45 of the length guide portion 40 to be removably inserted into the cavity 37 of the support member 30. For example, in a first, closed position, the fingers 45, or a portion of the fingers 45, of the length guide portion 40 may reside within the cavity 37, passing through the openings 35 in the bottom surface portion 39 of the support member 30, as shown in FIG. 7. In a second, extended position, the fingers 45, or a portion thereof, may extend a distance from the support member 30, as shown in FIG. 8. The support member 30 may be formed of materials such as plastics, polymers, bendable metals or composite materials that facilitate a rigid body. Manufacture of the support member 30 may include casting, extruding, cutting, turning, drilling, knurling, injection molding, spraying, blow molding, component overmolding, combinations thereof, or other fabrication methods that may provide efficient production of the component.

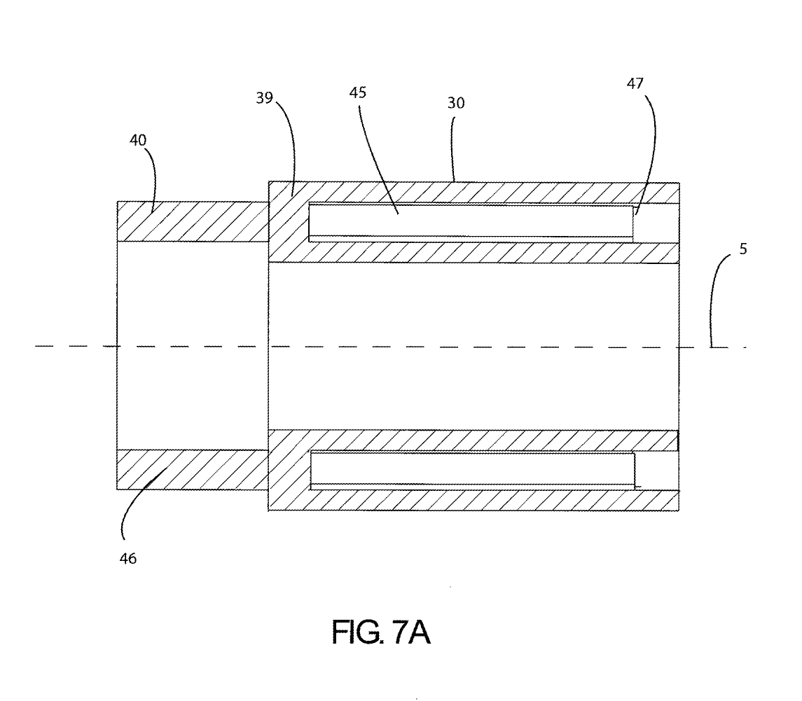

Referring to FIGS. 6-8, embodiments of seal trimmer 100 may also include a length guide portion 40 operably attached to the support member 30 to assist in determining an amount of the seal 80 that needs to be trimmed. The length guide portion 40 may be an adjustable length guide/structure/member configured to be variably disposed within the support member 30. The adjustable length guide portion 40 may include a first end 41, a second end 42, an inner surface 43, and an outer surface 44, and may be a generally annular member having a generally axial opening therethrough. Furthermore, embodiments of the length guide portion 40 may comprise a body portion 46 and one or more fingers 45 configured to extend into the cavity 37 of the support member 30 through the openings 35 in the bottom surface portion 39 of the support member 30, as shown in FIGS. 7A and 7B. The body portion 46 may be an annular member configured to engage the base portion 25 of the port 20, and/or to be gripped by an installer for determining the required length of a seal 80. The one or more fingers 45 may be structurally integral with the body portion 46, and may extend substantially axially from the body portion 46; each finger may be separated by a gap or opening. The fingers 45 may provide some resiliency to the length guide portion 45 in the radial direction; the resiliency may allow for interchangeability of length guide portions 40 of different lengths. Because the length guide portion 40 is generally annular, the individual finger(s) may have a cross-section that is curvilinear, C-shaped, arcuate, and the like. The length guide portion 40 may be formed of materials such as plastics, polymers, bendable metals or composite materials that facilitate a rigid body. Manufacture of the length guide portion 40 may include casting, extruding, cutting, turning, drilling, knurling, injection molding, spraying, blow molding, component overmolding, combinations thereof, or other fabrication methods that may provide efficient production of the component.

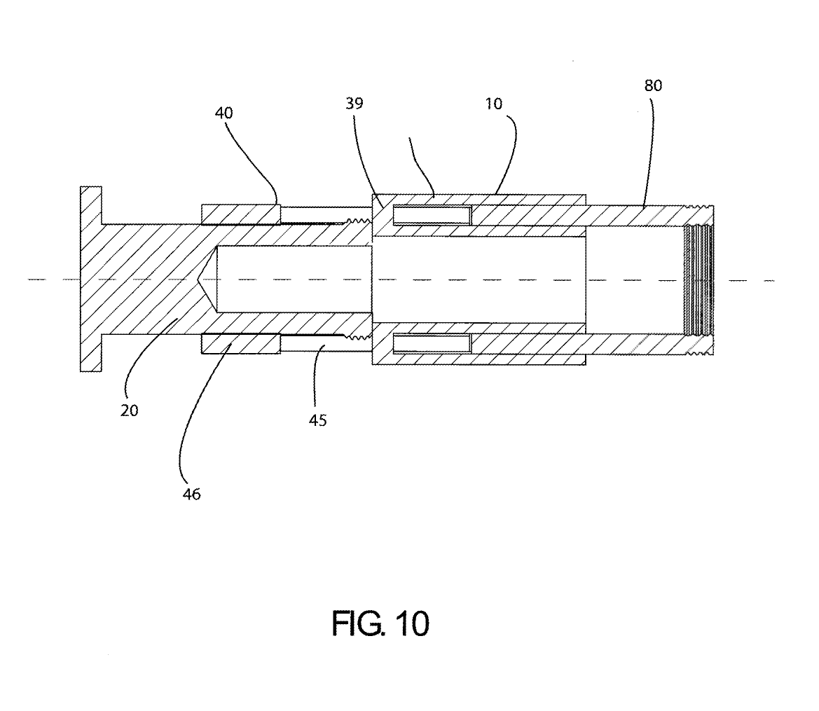

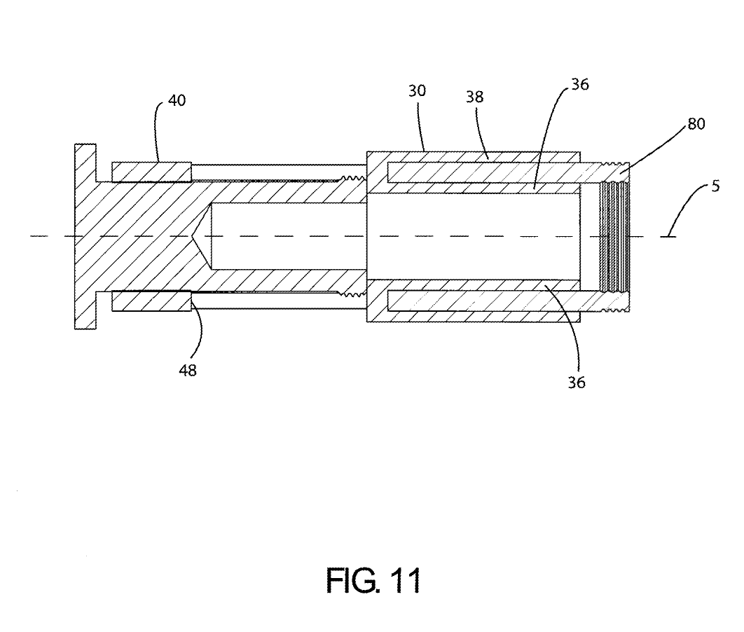

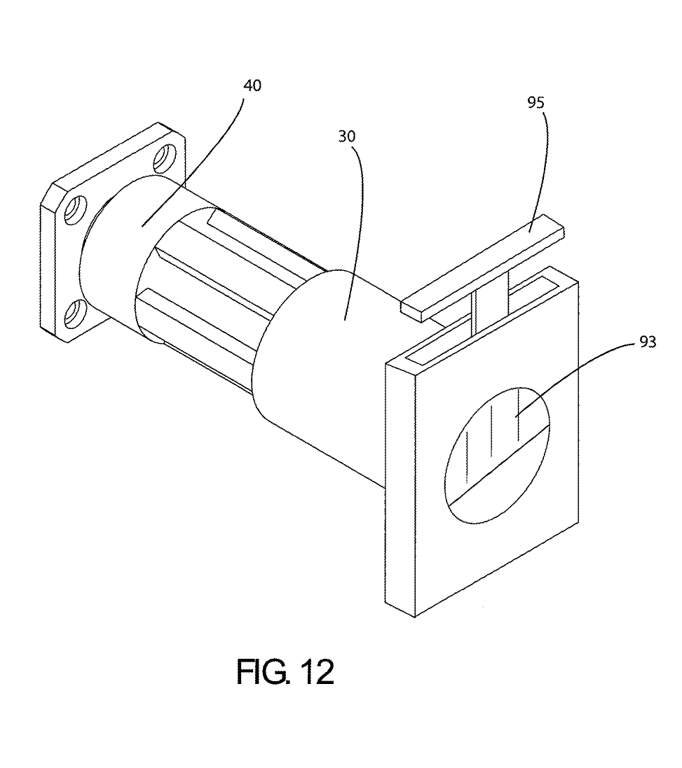

With continued reference to FIGS. 6-8, and additional reference to FIGS. 9-11, embodiments of the one or more fingers 45 connected to the body portion 46 may be displaced from the cavity 37 of the support member 30 by the seal 80 as the seal 80 is inserted into the support member 30, driving the body portion 46 of the length guide portion 40 into the base portion 25 of the port 20. FIG. 9 depicts an embodiment of a first, closed position, wherein the finger(s) resides within the cavity 37 of the support member 30 prior to insertion of the seal 80. FIG. 10 depicts an embodiment of a position between the closed and extended position, wherein the seal 80 has been inserted into the support member 30 to axially displace the length guide portion 40, in particular, the fingers 45, from the cavity 37 through the openings 35 towards the base portion 25 of the port 20. FIG. 11 depicts an embodiment of the second, extended position, wherein the inserted seal 80 has axially displaced the length guide portion 40 to the base portion 25 of the port 20 to determine the proper size of the seal 80. Thus, the length guide portion 40 may extend from the support member 30 the length of the port 20; the portion 83 of the seal 80 that remains exposed beyond the second end 32 of the support member 30 after the length guide portion 40 engages the base portion 25 of the port 20 can be trimmed by a installer's blade or an integral cutting means 90. For instance, the distance the length guide portion 40 displaces may equal the required size of the seal 80, and the excess portion 83may be trimmed. Alternatively, an installer may place the seal trimmer 100 onto an end of the port 20, and advance the length guide portion 40 (e.g. by gripping the body portion 46) to a depth appropriate for the desired seal length and then place the seal trimmer 100 onto the seal 80 for cutting.

Embodiments of the length guide portion 40 may not include a body portion 46 and simply comprise one or more fingers 45 that may independently be displaced by from the cavity 37 to the base portion 25 of the port 20 as the seal 80 is inserted into the support member 30. For example, the length guide portion 20 may comprise a single axial member, such as a C-shaped peg, that may extend from the support member 30 through an opening 35 to the base portion 25 of the port 20 to determine the proper length of the seal.

Furthermore, embodiments of the length guide portion 40 may include a structural feature 47 that can prevent the length guide portion 40 from extending completely through the openings 35 in a direction towards the first end 31 of the support member 30 and disconnecting from the support member 30. For example, the fingers 45 may include a structural feature 47 at an end of the finger 45 to engage with the bottom surface portion 39 of the support member 30 to prevent unwanted disengagement from the support member 30. The structural feature 47 may be a lip, protrusion, or other suitable surface feature that may engage with the bottom surface portion 39 of the support member 30. For example, the area of the openings 35 may be slightly smaller than the area of a cross-section of the cavity 37 to facilitate engagement with the structural feature 47, such as lip to further prevent excessive displacement of the length guide portion 40. Further embodiments of the support member 30 may include a bottom surface portion 39 that has a surface feature to correspondingly engage the structural feature 47 of the length guide portion 40. Moreover, the thickness, girth, or overall size of the fingers 45 of the length guide portion 40 may correspond to the thickness or overall size of the cavity 37. In one embodiment, the size of the fingers 45 may establish an interference fit between the inner sleeve portion 36 and the outer sleeve portion 38 to avoid unwanted movement or displacement of the length guide portion 40 (i.e. movement/displacement not caused by the seal 80). For instance, the mechanical interference between the fingers 45 of the length guide portion 40 and the inner and outer sleeve portions 36. 38 may allow axial movement of the fingers 45 back and forth in the cavity 37 when subjected to an external force, such as the force exerted by the seal 80 when an installer inserts the seal 80 into the support member 30, but prevent or substantially hinder axial movement when no external force is applied.

With reference now to FIG. 12, embodiments of the seal trimmer 100 may include a cutting means 90. The cutting means 90 may be operably attached to the support member 30 proximate or otherwise near the second end 32. Embodiments of the cutting means 90 may be integral with the support member 30, forming a one piece component. The cutting means 90 may incorporate a scissors, cigar-style trimmer, guillotine-like blade action, or other cutting mechanism, integrally disposed proximate the second end 32 of the support member 30 to cut off/trim the exposed portion 83 of the seal 80. Embodiments of a the cutting means 90 may be an integral cutting means having a blade 93 operably connected to an actuator 95, wherein actuation (i.e. pushing, sliding, squeezing, etc.) operates the blade 93 in a manner which may slice through the seal 80 along the outer sleeve portion 38 of the support member 30. The blade 93 may be integrally positioned at the second end 32 of the support member, adjacent to the outer sleeve portion 38. Those skilled in the art should appreciate that various cutting means and cutting motions may be incorporated to trim the exposed portion 83 of the seal 80 proximate or at the edge of the outer sleeve portion 38. Alternatively, the seal trimmer 100 may be removably attached or secured to a standard cutting device.

Referring now to FIGS. 1-12, embodiments of a method of determining a desired length of a port seal 80 may include the steps of providing an annular member 30 having an inner sleeve portion 36 and an outer sleeve portion 38 defining a cavity 37 therebetween, and a length guide portion 40 variably disposed within the cavity 37 of the annular member 30, advancing the length guide portion 40 towards a base portion 25 of a port 20 to vacate a portion of the cavity 27 and inserting the port seal 80 into the vacated cavity 37 of the annular member 30. Another method of determining a desired length of a port seal 80 may include the steps of providing a support member 30 having an inner sleeve portion 36 and an outer sleeve portion 38 defining a cavity 37 therebetween, and a length guide portion 40 variably disposed within the cavity 37 of the support member 30, inserting the seal 80 into a second end 32 of the support member 30 to axially displace the length guide portion 40 from the cavity 37, and trimming an exposed portion 83 of the seal 80 beyond the second end 32 of the support member 30.

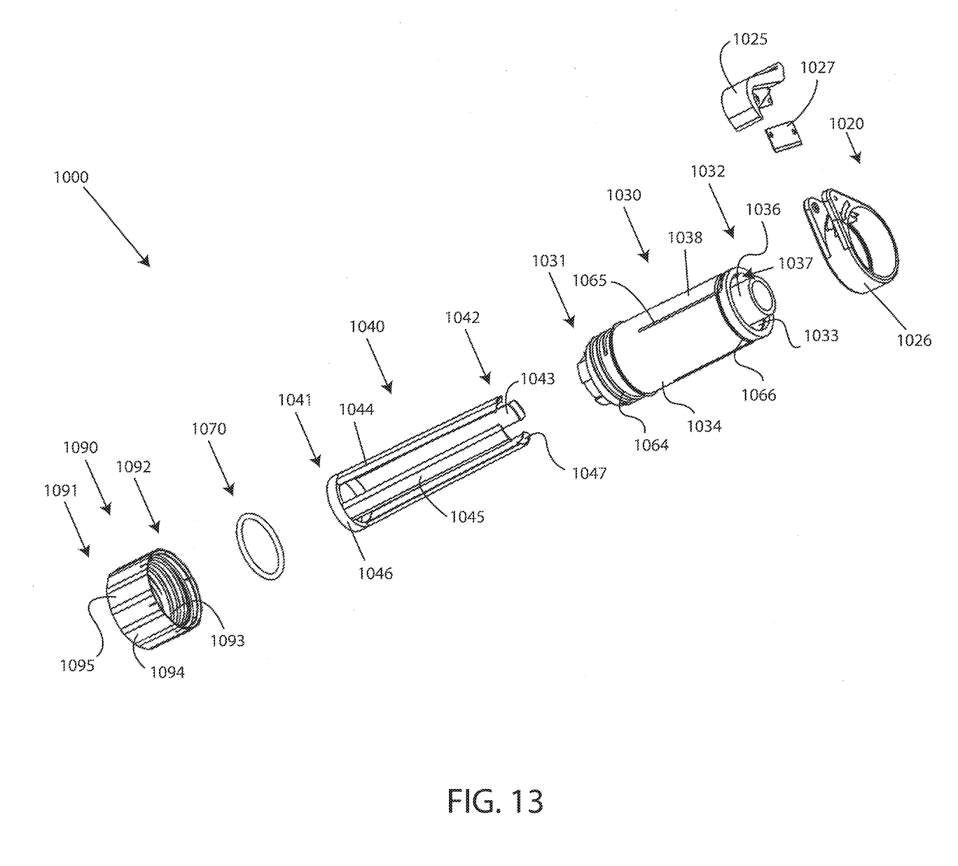

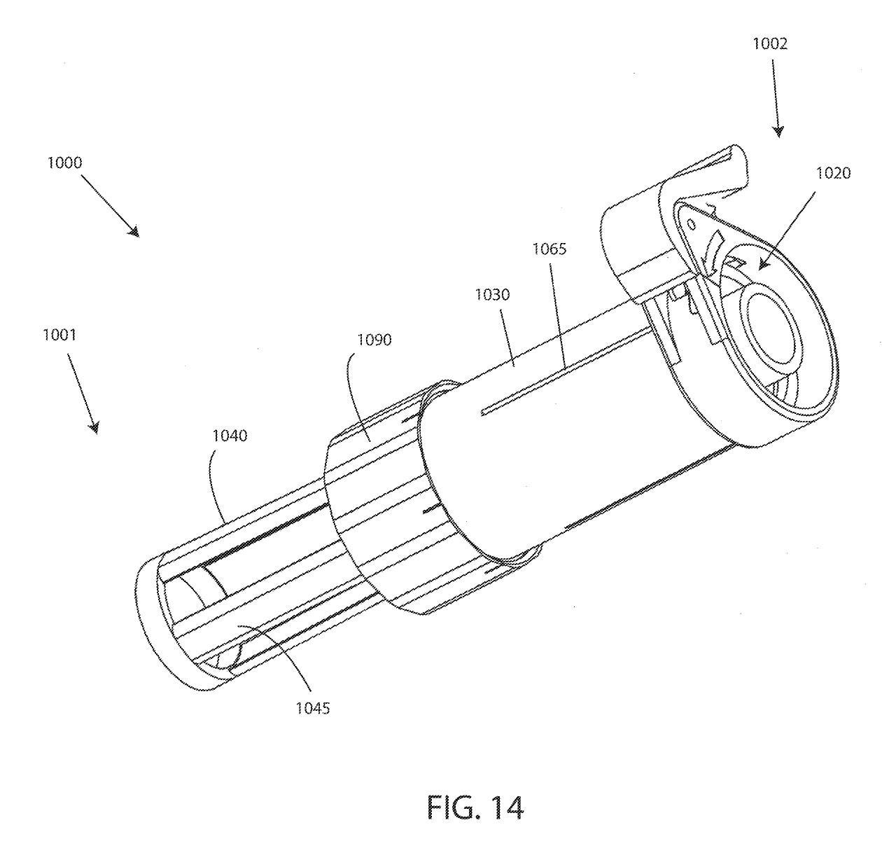

Referring still to the drawings, FIGS. 13 and 14 depict an embodiment of a port seal trimmer 1000. Embodiments of a port seal trimmer 1000 may share the same or substantially the same structural and functional aspects of seal trimmer 100. However, embodiments of the seal trimmer 1000 may include a support member 1030, a length guide portion 1040, a retention feature 1090, an O-ring 1070, and a rotary cutting means 1020. For instance, embodiments of the seal trimmer 1000 may include a support member 1030 having a first end 1031 and a second end 1032, and a guide portion 1040 variably disposed within the support member 1030. Accordingly, seal trimmer 1000 may be used to trim the lengths of a seal, such as a port seal, for placement over a port, such as port 20, and may prevent the occurrence of irregularities on a cut surface of the seal 80 that may occur when the seal 80 deforms under the force of an installer's knife. Embodiments of the seal trimmer 1000 may be provided to an installer in a preassembled configuration or may be assembled as needed to allow for interchangeability of components (e.g. installer may assemble and disassemble a seal trimmer 1000 having a support member 1030 and a length guide portion 1040 having a first size, and swap it out with a length guide portion 1040 having a second size).

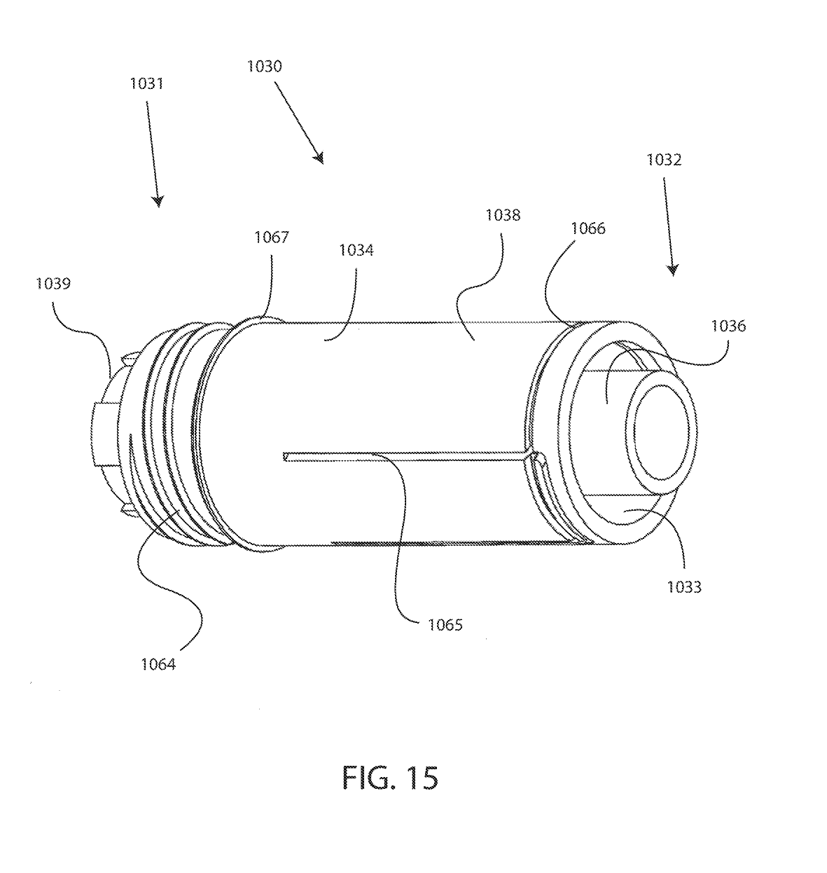

With reference still to FIGS. 13 and 14, and with additional reference to FIG. 15, embodiments of a seal trimmer 1000 may include a seal support member 1030; embodiments of the support member 1030 may share the same or substantially the same structure and function as support member 30. Embodiments of the support member 1030 may accommodate, receive, accept, etc., a seal 1080, and may structurally support or prevent the inward deformation of the seal 80 when the seal 80 is being trimmed. In other words, a seal 80 may be insertable within the support member 1030 to displace a guide portion 1040, described in greater detail supra. The support member 1030 may include a first end 1031, a second end 1032, an inner surface 1033, an outer surface 1034, and a bottom surface portion 1039. The support member 1030 may be an annular member having a generally axial opening therethrough. Furthermore, the support member 1030 may also include a first portion 1036 and a second portion 1038. The inner sleeve portion 1036 and the outer sleeve portion 1038 may be a sleeve, or similar cylindrical shaped portion; however, the inner and outer sleeve portions 1036, 1038 need not be a continuous cylinder to function properly. Moreover, embodiments of the support member 1030 may include a threaded outer surface feature 1064 proximate or otherwise near the first end 1031. The threaded outer surface 1064 may be configured to threadably mate with an inner threaded surface 1093 of the retention feature 1090. The pitch and depth of the threads of the outer threaded surface feature 1064 may vary and may matingly correspond to the pitch and depth of the threads of the threaded inner surface 1093. Embodiments of the support member 1030 may also include an annular lip 1067. The annular lip 1067 may matingly engage with an internal lip 1096 of the retention feature 1090 when operably configured. For instance, the engagement between the annular external lip 1067 of the support member 1030 and the annular internal lip 1096 of the retention feature 1090 may help secure the two components together.

Furthermore, embodiments of the support member 1030 may include one or more axial slots 1065 extending a distance across the support member 1030, in particular, the second portion, or outer sleeve portion 1038. Embodiments of the axial slots 1065 may be an opening, a channel, a slot, a groove, and the like. In some embodiments, the axial slots 1065 may begin from an end of the first portion 1038, and extend an axial distance towards the first end 1031 of the support member 1030. The one or more axial slots 1065 may allow the second portion, or outer sleeve portion 1038 to flex when compressed. For instance, the one or axial slot 1065 may allow radial deflection of the outer sleeve portion 1038 when an installer grips, holds, or squeezes the support member 1030, wherein the radial deflection exerts a contact force upon the seal 80 inserted in between the outer sleeve portion 1038 and inner sleeve portion 1036. Because the outer sleeve portion 1038 of the support member 1030 may be flexible, the installer can essentially control the seal 80, or prevent or restrict movement of the seal 80 between the first and second portion 1036, 1038 when holding or otherwise operating the seal trimmer 1000. Additionally, the support member 1030, or the outer sleeve portion 1038, may include an annular groove 1066 proximate or otherwise near the second end 1032. The annular groove 1066 may cooperate with an external annular lip 1026d of the rotary cutting means 1020. Embodiments of the annular groove 1066 may be an opening, a groove, a detent, tunnel, channel, recess, and the like. Embodiments of the annular groove 1066 may facilitate rotational movement of the rotary cutting means 1020 around the support member 1030, yet may also restrict, prevent, and/or hinder axial movement of the components with respect to each other.

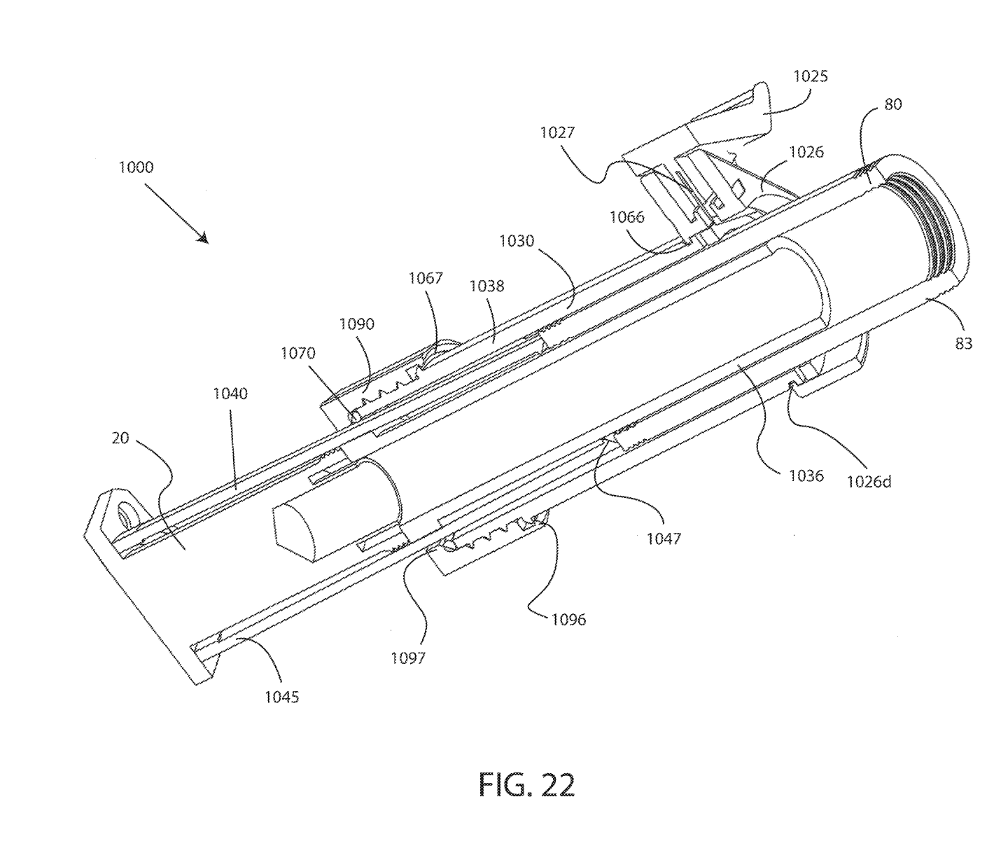

Embodiments of an inner sleeve portion 1036 and an outer sleeve portion 1038 can be structurally integral with a common bottom surface 1039 of the support member 1030. However, the inner sleeve portion 1036 and the outer sleeve portion 1038 may be separated by a distance, defining a cavity 1037. The distance separating the inner sleeve portion 1036 and the outer sleeve portion 1038 defining cavity 1037 should be at least enough to accommodate a thickness, t, of the seal 80, as described above in association with trimmer 100. Furthermore, embodiments of the inner sleeve portion 1036 of the support member 1030 may be configured to be inserted within the axial opening of the seal 80 (e.g. insertable within an inner diameter of the seal 80). For instance, the seal 80 may be disposed over the inner sleeve portion 1036 but within the outer sleeve portion 1038 and slid further towards the first end 1031 of the support member 1030. Once the seal 80 is slid into the support member 1030 the requisite distance, an exposed portion 83 of the seal 80 may be cut off to trim the seal 80, as shown in FIG. 22. The inner sleeve portion 1036, due to its rigid characteristics, may prevent the seal 80 from squashing or otherwise deforming under the cutting force of an installer's blade, or a cutting blade 1027 of the rotary cutting means 1020, because the seal 80 is disposed over the inner sleeve portion 1036. Moreover, the inner sleeve portion 1036 may act as a structural cutting edge for ensuring an even, continuous cut completely around the seal 80. Thus, the support provided by the inner sleeve portion 1036 to the seal 80 when trimming and/or cutting the exposed portion 83 with the rotary cutting means 1020, or other cutting device, may reduce or eliminate the likelihood of notches, serrations, or other surface irregularities that may lead to a discontinuous cut surface.

Furthermore, embodiments of the outer sleeve portion 1038 of the support member 1030 may be configured to surround a portion of the inserted seal 80, as described above in association with trimmer 100. Similar to embodiments of support member 30 shown in FIGS. 3 and 4, embodiments of the support member 1030 may include one or more openings on the bottom surface portion 1039 proximate the first end 1031 of the support member 1030. The openings may be sized and dimensioned to provide clearance to allow fingers 1045 of the length guide portion 1040 to be variably inserted into the cavity 1037 of the support member 1030. For instance, the fingers 1045 of the length guide portion 1040 may snap into the openings of the support member 1030, and may be retained by a retainer feature 1047 so as to prevent the fingers 1045 from completely unintentionally disengaging from the support member 1030. Embodiments of the support member 1030 may be formed of materials such as plastics, polymers, bendable metals or composite materials that facilitate a rigid, yet flexible body. Manufacture of the support member 1030 may include casting, extruding, cutting, turning, drilling, knurling, injection molding, spraying, blow molding, component overmolding, combinations thereof, or other fabrication methods that may provide efficient production of the component.

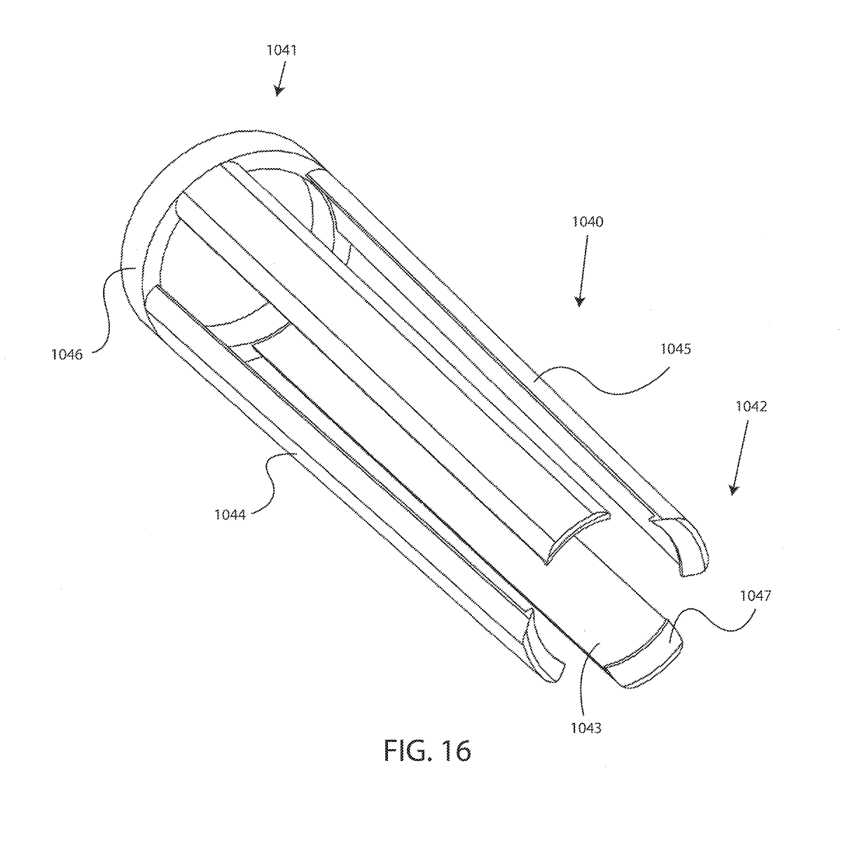

Referring again to FIGS. 13 and 14, and with additional reference to FIG. 16, embodiments of seal trimmer 1000 may also include a length guide portion 1040 operably attached to the support member 1030 to assist in determining an amount of the seal 80 that needs to be trimmed. Embodiments of the guide portion 1040 may share the same or substantially the same structural and functional aspects as guide portion 40 described above. For instance, the length guide portion 1040 may be an adjustable length guide/structure/member configured to be variably disposed within the support member 1030, and may include a first end 1041, a second end 1042, an inner surface 1043, and an outer surface 1044. Furthermore, embodiments of the length guide portion 1040 may comprise a body portion 1046 and one or more fingers 1045 configured to extend into the cavity 1037 of the support member 1030 through the openings in the bottom surface portion 1039 of the support member 1030. Embodiments of the fingers 1045 proximate the second end 1042 may include a retainer feature 1047, such as structural feature 45 described above. Embodiments of the retainer feature 1047 may include a ramped surface to allow the second end 1042 of the fingers 1045 to snap into the openings on the bottom surface portion 1039, yet retaining the guide portion 1040 at least partially within the support member 1030. Other embodiments of the retainer feature 1047 may include any surface feature that protrudes a distance from the inner surface 1043 of the fingers 1045, and presents a flat or substantially flat engagement surface configured to engage a flat or substantially flat surface formed by the internal surface of the bottom surface portion 1039. Moreover, as described with respect to the guide portion 40 of trimmer 100, and as shown in FIG. 22, the guide portion 1040, including the one or more fingers 1045 connected to the body portion 1046 may be displaced from the cavity 1037 of the support member 1030 by the seal 80 as the seal 80 is inserted into the support member 1030, driving the body portion 1046 of the length guide portion 1040 into the base portion 25 of the port 20. Alternatively, an installer may manually pull the guide portion 1040 out from the support member 1030 a distance so as it would, or does, reach the base portion 25 of the port 20. Embodiments of the length guide portion 1040 may be comprised of plastic, composites, a metal, or a combination of plastic and metal. Manufacture of the length guide portion 1040 may include casting, extruding, cutting, turning, drilling, knurling, injection molding, spraying, blow molding, component overmolding, combinations thereof, or other fabrication methods that may provide efficient production of the component.

Embodiments of the length guide portion 1040 may not include a body portion 1046 and may simply comprise one or more fingers 1045 that may independently be displaced by from the cavity 1037 to the base portion 25 of the port 20 as the seal 80 is inserted into the support member 1030. For example, the length guide portion 1040 may comprise a single axial member, such as a C-shaped peg, that may extend from the support member 1030 through an opening of the bottom surface portion 1039 to the base portion 25 of the port 20 to determine the proper length of the seal and/or the requisite amount of the seal 80 that needs to be trimmed.

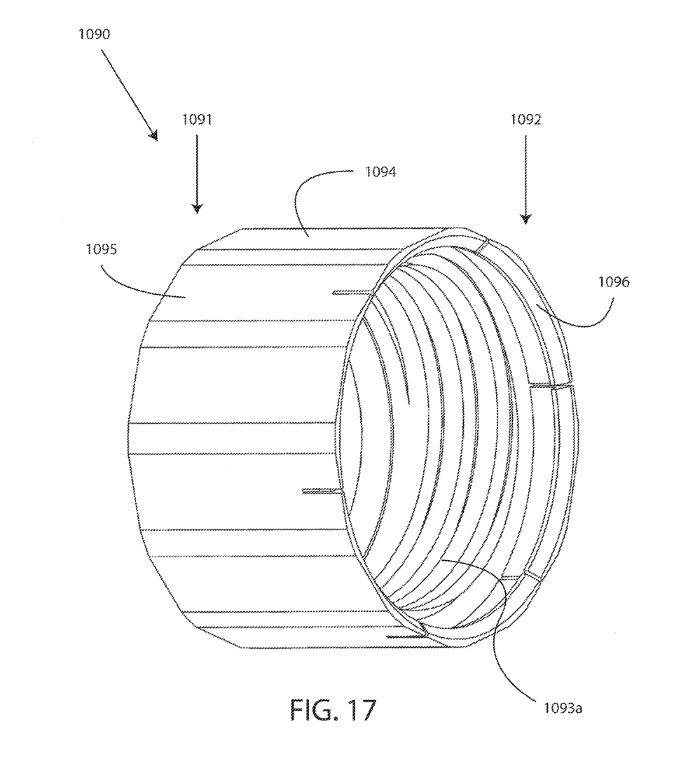

Continuing to refer to FIGS. 13 and 14, and now with additional reference to FIG. 17, embodiments of the seal trimmer 1000 may include a retention feature 1090. Embodiments of the retention feature 1090 may include a first end 1091, a second end 1092, a threaded inner surface 1093, and an outer surface 1094. Embodiments of the retention feature 1090 may be a generally annular member having a generally axial opening therethrough. The retention feature 1090 may be configured to threadably mate with the exterior threaded surface portion 1064 of the support member 1030. For instance, when the guide portion 1040 is operably assembled at least partially within the support member 1030, the retention feature 1090 may be threaded onto the exterior threaded surface portion 1064. An O-ring 1070 may be disposed proximate the bottom surface portion 1039, wherein when the retention feature 1090 is threaded onto the support member 1030, the O-ring 1070 can be compressed against the fingers 1045 of the guide portion 1040 to add resistance and/or friction to the fingers 1045 and help retain the component within the support member 1030. Embodiments of the retention feature 1090 may include an annular lip 1097 proximate or otherwise near the first end 1091 to retain the O-ring 1070 into position, while also providing a surface to compress the O-ring 1070 when the retention feature 1090 is threaded, or in some cases, fully threaded, onto the support member 1030. Embodiments of the annular lip 1097 may be an annular protrusion defining a reduction in an inner diameter of the retention feature 1090 proximate or otherwise near the first end 1091. As shown in FIG. 22, the O-ring 1070 may be compressed between the annular lip 1097 of the retention feature 1090 and an external face of the bottom surface portion 1039 to add resistance to the axial movement of the fingers 1045 of the guide portion 1040 within the support member 1030. In some embodiments, the O-ring 1070 may be any elastomeric material that compresses under normal and/or foreseeable use of the seal trimmer 1000, and may also be a pliable, or malleable metal that similarly compresses under normal and/or foreseeable use of the seal trimmer 1000. The O-ring could also be a piece of plastic. In other words, embodiments of the seal trimmer 1000 may include any component(s) or surface feature(s) that can apply an amount of resistance or friction to potentially lock the guide portion 1040 in an axial position with respect to the support member 1030. Accordingly, the retention feature 1090 may act as a locking feature or a friction brake when threaded onto the support member 1030 and essentially lock the fingers 1045 in place at a particular axial location with respect to the support member 1030. This can be advantageous to the installer because once the seal 80 is inserted into the cavity 1037 of the support member 1030 and the fingers 1045 of the length guide portion 1040 have been displaced either manually by the user or by the inserted seal, a requisite distance, the installer may start to tighten or continue to further tighten the retention feature 1090 to a tightened position to lock, secure, retain, etc., the fingers 1045 in place to try and prevent unwanted axial movement of the fingers 1045 which may affect the length of the exposed seal portion 83 that needs to be trimmed (i.e. cut). Additionally, it may be possible for the installer to thread and unthread the retention feature 1090 to increase or decrease the resistance/friction supplied to the fingers 1045 within the support member 1030 when an installer inserts a seal 80 within the seal trimmer 1000. However, those skilled in the art should appreciate that some embodiments of the seal trimmer 1000 do not need to rely on compression of an O-ring or other friction brake to supply resistance; the fingers 1045 may share an interference fit within the inner and outer sleeve portions 1036, 1038 while operably configured.

Additionally, embodiments of the outer surface 1094 of the retention feature 1090 may comprise a plurality of flat surface sections to enhance gripping by an installer's fingers, or if needed, the gripping of a wrench or similar tool. For example, the outer surface 1094 may include hex or polygonal flats of various size alternately arranged to provide torque-enhancement for threading and unthreading the retention feature 1090. Embodiments of the retention feature 1090 may further include an annular internal lip 1096 proximate or otherwise near the second end 1092. The internal annular lip may be configured to cooperate with the annular lip 1067 of the outer sleeve portion 1038 to facilitate continued attachment of the two components. Moreover, embodiments of the retention feature 1090 may be comprised of plastic, composites, a metal, or a combination of plastic and metal. Manufacture of the retention feature 1090 may include casting, extruding, cutting, turning, drilling, knurling, injection molding, spraying, blow molding, component overmolding, combinations thereof, or other fabrication methods that may provide efficient production of the component.

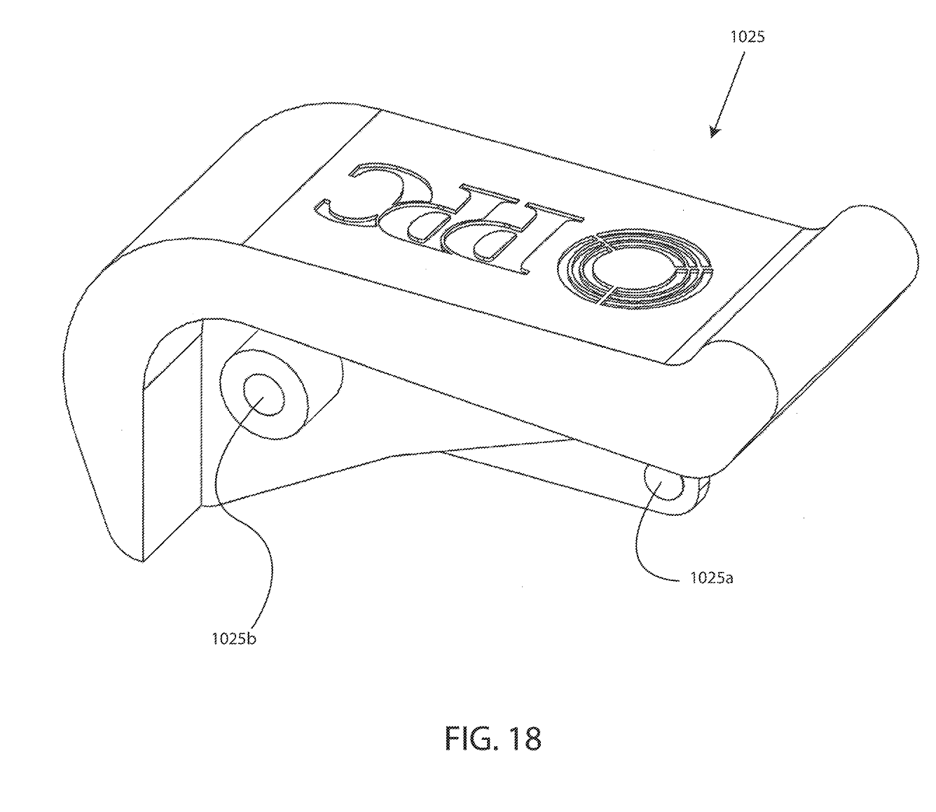

Referring still to FIGS. 13 and 14, and additional reference to FIGS.18-21, embodiments of the adjustable seal trimmer 1000 may include a rotary cutting means 1020. Embodiments of the rotary cutting means 1020 may be operably connected to the support member 1030 proximate or otherwise near the second end 1032. For instance, the rotary cutting means 1020 may be attached to the outer sleeve portion 1038 in a position to trim, cut, slice, etc. an exposed or excess portion 83 of the seal 80. The rotary cutting means 1020 may be rotated or twisted around the support member 1030 to cut an exposed portion 83 of the seal 80 in a circular fashion to effectuate an even cut entirely around the seal 80. In other words, an installer may rotate the cutting means 1020 (or alternatively rotate the seal trimmer 1000) 360° to engage the seal 80 and accurately cut the seal 80 to a desired length, while avoiding uneven or irregular cutting of the seal 80. Embodiments of the rotary cutting means 1020 may be rotatable with respect to the support member 1030, but axial movement with respect to the support member 1030 may be hindered.

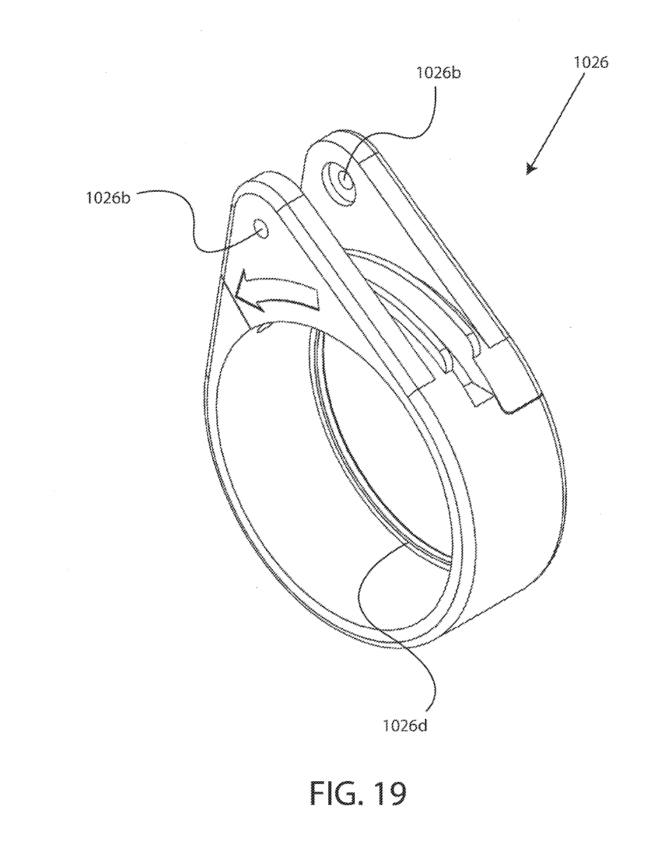

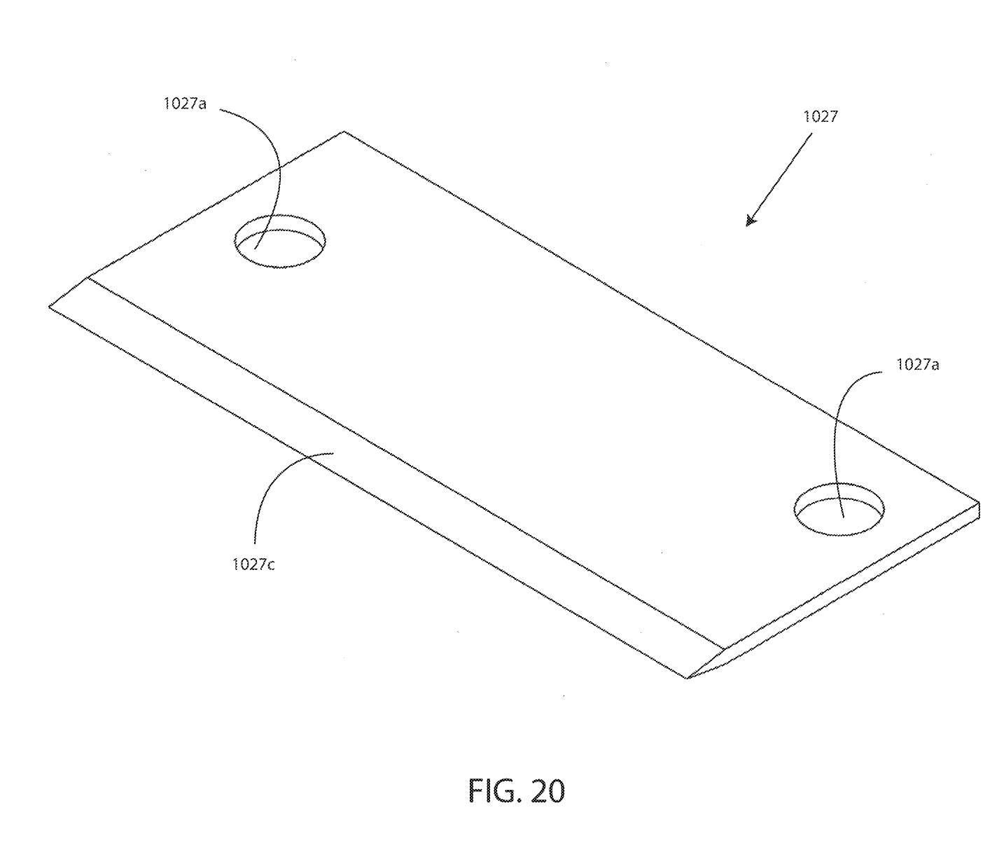

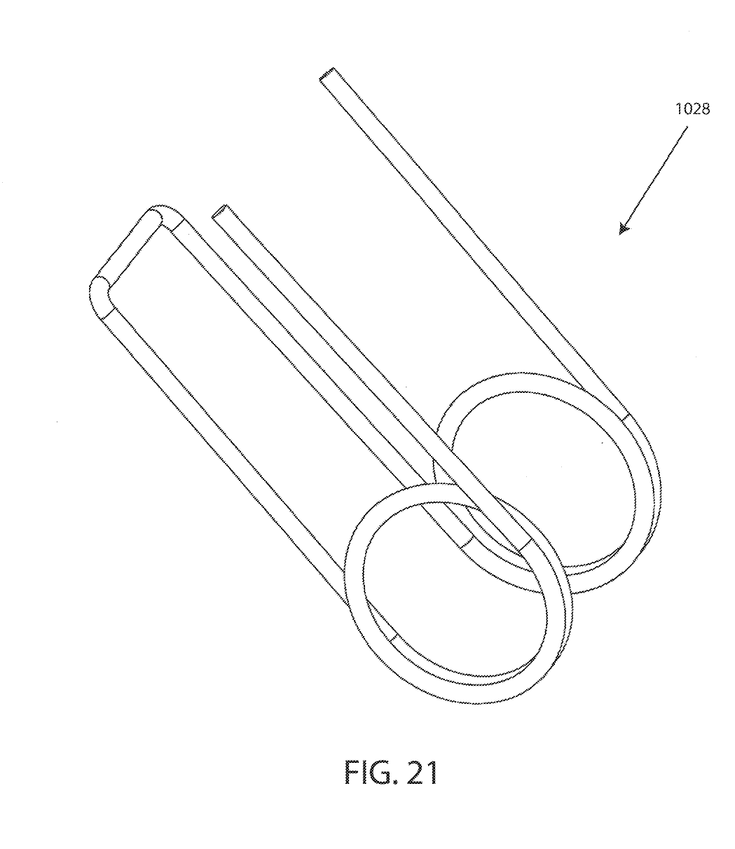

Embodiments of the rotary cutting means 1020 may include an actuator 1025, a base portion 1026, a blade 1027, and a spring means 1028. FIG. 18 depicts an embodiment of an actuator 1025. Embodiments of the actuator 1025 may be a button, arm, pivoting arm, lever, key, switch, push button, lock button, toggle, pedal, and the like. The actuator 1025 may be a pivoting arm that can be depressed or raised by an installer to effectuate the movement of the blade 1027 onto the seal 80 through cooperation with a spring means 1028. The actuator 1025 may be operably connected to the base portion 1026. Further embodiments of the actuator 1025 may include through-holes 1025b to facilitate connection with the base portion 1026, and may include through-holes 1025a to facilitate securement and/or attachment to the blade 1027. FIG. 19 depicts an embodiment of the base portion 1026 that is configured to be attached to the second end 1032 of the support member 1030. Embodiments of the base portion 1026 may include an annular protrusion 1026d that is configured to cooperate with an annular groove 1066 to facilitate rotational movement about the support member 1030 in a fixed axial location on the support member 1030. Further embodiments of the base portion 1026 may include through-holes 1026b for facilitating connection with the actuator 1025. FIG. 20 depicts an embodiment of a blade 1027 having a sharp edge 1027c and at least one through-hole 1027a for facilitating attachment and/or securement to the actuator 1025 and/or base portion 1026; those skilled in the art should appreciate that various sizes, designs, shapes, etc. of a blade 1027 may be used in connection with the rotary cutting means 1020. FIG. 21 depicts an embodiment of a spring means 1028 that may disposed proximate the base portion 1026 and the actuator 1025; the spring means 1038 may provide a biasing means, or resistance, to the actuator 1025 as the actuator 1025 is actuated to bring the blade 1027 into engagement with the port seal 80. Embodiments of the rotary cutting means 1025 may be configured to operate in a spring “closed” position or a spring “open” position. The spring “closed” position of the rotary cutting means 1025 may require an installer to raise or lift the actuator 1025 to raise the blade 1027 while inserting the port seal 80 into the seal trimmer 1000, and then releasing the actuator 1025 to bring the blade 1027 into contact with the port seal 80. Thus, the spring means 1028 may contribute to the downward cutting force of the blade 1027. The spring “open” position of the rotary cutting means 1020 may require that the installer depress or push down on the actuator 1025 to bring the blade 1027 into contact with the port seal 80. Thus, the spring means 1028 may work against the downward cutting force, but the seal can be inserted into the seal trimmer 1000 without needing to actuate the actuator 1025.

Referring now to FIG. 22, the manner in which the seal trimmer 1000 may trim or cut a port seal to a specific size will now be described. An installer may determine the size of a port seal 80 to environmentally protect the port 20 by operating the seal trimmer 1000. In some embodiments, the installer may place the seal trimmer 1000 proximate the port 20, and then insert a piece of a port seal 80 having an initial length. As the port seal is further inserted into the cavity 1037 between the outer sleeve portion 1038 and the inner sleeve portion 1026 of the support member 1030, the guide portion 1040 is displaced towards the port 20. Alternatively, an installer may manually displace the guide portion 1040 until the body portion 1046 can contact or contacts the base portion 25 of the port 20. Once the guide portion 1040 can reach or reaches the base portion 25 of the port 20 as shown in FIG. 22, a portion 83 of the seal 80 may be exposed at the second end 1032 of the support member 1030. The installer may then actuate the actuator 1025 of the rotary cutting means 1025 and rotate the cutting means 1020 to trim or cut the exposed portion 83 of the port seal 80 without moving the seal trimmer 1000 from the port 20. However, the installer may move the seal trimmer 1000 away from the port 20 and then cut the port seal 80. In some embodiments, after the guide portion 1040 can reach or reaches the base portion 25 of the port 20, the installer may thread the retention feature 1090 further onto the first end 1031 of the support member 1030 to add resistance or friction to the at least one finger 1045 of the guide portion 1040 to potentially lock the guide portion 1040 into place at a particular axial location with respect to the support member 1030. The added resistance of the retention feature 1090 to lock the guide portion 1040 into a position can assist the installer with the cutting of the seal 80 because the guide portion 1040 is less likely to move or turn during the cutting process. In addition, the locking feature or friction brake provided by threading the retention feature 1090 onto the first end 1031 of the support member 1030 may allow an installer to cut more than one port seal 80 to the same length without having to apply the seal trimmer 1000 to the port 20 because the guide portion 1040 will not likely have moved since the cutting of the previous port seal 80.

With reference to FIGS. 1-22, a method of sizing and cutting a port seal 80 to fit onto a port 20 may include the steps of providing a support member 30, 1030 having an inner sleeve portion 36, 1036 and an outer sleeve portion 38, 1038 defining a cavity 37, 1037 therebetween, and a length guide portion 40, 1040 variably disposed within the cavity 37, 1037 of the support member 30, 1030, inserting the port seal 80 into the cavity 37, 1037, and cutting an exposed portion 83 of the port seal 80. Embodiments of the method may further include the steps of providing a retention feature 1090 configured to threadably mate with a first end 1031 of the outer sleeve portion 1038, and providing a friction brake to lock the length guide portion 1040 into an axial position with respect to the support member 1030. Embodiments of the method may also include the step of rotating a rotary cutting means 1020 about a first end 1031 of the support member 1030.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and should not be limited to the specific examples provided herein.

What is claimed is:

1. A seal trimmer comprising:
a support member having a first end a second end; and
a guide portion variably disposed within the support member.

2. The seal trimmer of claim 1, a cutting means rotatably connected to the second end of the support member for trimming a portion of a port seal.

3. The seal trimmer of claim 1, further comprising:
a retention feature configured to threadably mate with the first end of the support member.

4. The seal trimmer of claim 3, wherein the retention feature cooperates with an O-ring to create a friction brake to lock the length guide portion into an axial position with respect to the support member.

5. The seal trimmer of claim 1, wherein an outer portion of the support member is flexible.

6. The seal trimmer of claim 1, wherein the support member includes a first portion and a second portion, the first portion and the second portion being structurally connected to a bottom surface portion of the support member.

7. The seal trimmer of claim 6, wherein a cavity is formed between the first portion and the second portion of the support member, the cavity configured to accept a port seal, the port seal axially displacing the length guide portion from the support member.

8. The seal trimmer of claim 1, wherein the guide portion includes a body portion and at least one finger extending from the body portion.

9. An apparatus comprising:
an inner sleeve portion;
an outer sleeve portion; and
at least one finger moveably disposed between the inner sleeve portion and the outer sleeve portion, the at least one finger configured to determine a length of a port seal.

10. The apparatus of claim 9, wherein the outer sleeve portion has at least one axial slot.

11. The apparatus of claim 9, further comprising:
a rotary cutting means rotatably connected to the outer sleeve portion, the rotary cutting means configured to cut a portion of the port seal.

12. The apparatus of claim 9, further comprising:
a retention feature configured to threadably engage the outer sleeve portion.

13. The apparatus of claim 12, wherein the retention feature compresses an O-ring to add resistance to a movement of the at least one finger.

14. The apparatus of claim 9, wherein the at least one finger includes a structural feature at one end to prevent complete disengagement with a bottom surface portion that structurally connects the outer sleeve portion and the inner sleeve portion.

15. The apparatus of claim 9, wherein the outer sleeve portion indicates a proximity of an end of the inner sleeve portion.

16. A seal trimmer comprising:
an annular member having an inner sleeve portion and an outer sleeve portion defining a cavity therebetween; and
a means for determining a desired length of a port seal and cutting the port seal.

17. The apparatus of claim 16, wherein the means comprises:
a rotary cutting means rotatably connected to the outer sleeve portion, the rotary cutting means configured to cut a portion of the port seal.

18. A method of sizing and cutting a port seal to fit onto a port, comprising:
providing a support member having an inner sleeve portion and an outer sleeve portion defining a cavity therebetween, and a length guide portion variably disposed within the cavity of the support member;
inserting the port seal into the cavity; and
cutting an exposed portion of the port seal.

19. The method of claim 18, wherein the step of providing further comprises:
providing a retention feature configured to threadably mate with a first end of the outer sleeve portion; and
providing a friction brake to lock the length guide portion into an axial position with respect to the support member.

20. The method of claim 18, wherein the step of cutting includes rotating a rotary cutting means about a first end of the support member.
